(19) United States
(12) Patent Application Publication
(10) Pub. No.: US 2025/0214625 A1
(43) Pub. Date: Jul. 3, 2025

(54) VEHICLE SENSOR CONFIGURATIONS BASED ON OPERATIONAL CONTEXTS

(71) Applicant: GM Cruise Holdings LLC, San Francisco, CA (US)

(72) Inventor: Sandeep Gangundi, San Jose, CA (US)

(21) Appl. No.: 18/402,445

(22) Filed: Jan. 2, 2024

(51) Int. Cl. B60W 60/00; B60W 50/00

(52) U.S. Cl. CPC B60W 60/0018; B60W 50/0097; B60W 2420/403; B60W 2420/408; B60W 2420/54; B60W 2520/06; B60W 2520/10; B60W 2552/05; B60W 2554/4044; B60W 2554/802; B60W 2555/20; B60W 2555/60; B60W 2556/40

(57) ABSTRACT

Systems and techniques are provided for dynamically implementing vehicle sensor configurations based on operational contexts. An example method can include detecting, based on at least one of map data and sensor data from at least one sensor on a vehicle, one or more characteristics of an operational context of the vehicle; determining, based on the one or more characteristics of the operational context, a sensor configuration for the vehicle to implement when navigating the operational context, the sensor configuration comprising one or more sensors selected for use by the vehicle in the operational context and one or more different sensors set to an off state or a reduced operating mode while the vehicle is in the operational context; and dynamically implementing the sensor configuration at the vehicle when the vehicle is in the operational context.

### TECHNICAL FIELD

The present disclosure generally relates to use of sensors for autonomous driving operations. For example, aspects of the present disclosure relate to techniques and systems for dynamically selecting vehicle sensor configurations based on vehicle operational contexts.

### BACKGROUND

An autonomous vehicle is a motorized vehicle that can navigate without a human driver. An example autonomous vehicle can include various sensors such as, for example, camera sensors, light detection and ranging (LIDAR) sensors, time-of-flight (TOF) sensors, and radio detection and ranging (RADAR) sensors, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors can be mounted at fixed locations on the autonomous vehicles.

### BRIEF DESCRIPTION OF THE DRAWINGS

Illustrative examples and aspects of the present application are described in detail below with reference to the following figures:

FIG. 1 is a diagram illustrating an example system environment that can be used to facilitate autonomous vehicle (AV) navigation and routing operations, according to some examples of the present disclosure;

FIG. 2 is a diagram illustrating example vehicle sensor configurations dynamically selected for different operational contexts of a vehicle, according to some examples of the present disclosure;

FIG. 3 is a flowchart illustrating an example process for dynamically implementing vehicle sensor configurations based on operational contexts, according to some examples of the present disclosure;

FIG. 4 is a diagram illustrating an example system architecture for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of the subject matter of the application. However, it will be apparent that various aspects and examples of the disclosure may be practiced without these specific details. The figures and description are not intended to be restrictive.

The ensuing description provides examples and aspects of the disclosure, and is not intended to limit the scope, applicability, or configuration of the disclosure. Rather, the ensuing description of the examples and aspects of the disclosure will provide those skilled in the art with an enabling description for implementing an example implementation of the disclosure. It should be understood that various changes may be made in the function and arrangement of elements without departing from the scope of the application as set forth in the appended claims.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As previously explained, autonomous vehicles (AVs) can include various sensors such as, for example and without limitation, camera sensors, light detection and ranging (LIDAR) sensors, radio detection and ranging (RADAR) sensors, inertial measurement units (IMUs), time-of-flight (TOF) sensors, ultrasonic sensors, global navigation satellite systems (GNSS), and/or global positioning system (GPS) receivers, amongst others. The AVs can use the various sensors to collect data and measurements that the AVs can use for AV operations such as perception (e.g., object detection, event detection, tracking, localization, sensor fusion, point cloud processing, image processing, etc.), planning (e.g., route planning, trajectory planning, situation analysis, behavioral and/or action planning, mission planning, etc.), control (e.g., steering, braking, throttling, lateral control, longitudinal control, model predictive control (MPC), proportional-derivative-integral, etc.), prediction (e.g., motion prediction, behavior prediction, even prediction, etc.), etc. The sensors can provide the data and measurements to an internal computing system of an AV, which can use the data and measurements to control a mechanical system of the AV, such as a vehicle propulsion system, a braking system, and/or a steering system, for example.

In many cases, the sensors used by an AV for AV operations and the associated sensor data processed by the AV for AV operations can be computationally expensive (e.g., compute intense). For example, AVs can use a large number of sensors and process vast amounts of associated sensor data, which can increase the sensing capabilities and real-time decision-making calculations of the AVs. The AVs can use the various sensors to continuously scan and monitor the environment in order to sense road conditions, track location information, and understand the surroundings of the AVs. However, the number of sensors that an AV runs and the amount of associated sensor data that the AV processes increase, the demands for power and compute resources (e.g., computer processing, storage, memory, etc.) from such sensors and sensor data processing also increase, which can create significant power and resource burdens on the AV. Moreover, the large volume of sensor data generated by the AV sensors and processed by the AV can increase computer/processing latencies and create other pressures on the AVs' computational resources.

In some aspects, systems, apparatuses, processes (also referred to as methods), and computer-readable media (collectively referred to as “systems and techniques”) are described herein for dynamically selecting vehicle sensor configurations based on vehicle operational contexts. In some examples, the systems and techniques described herein can be used by a vehicle to dynamically select and implement different sensor configurations when the vehicle operates in different operational contexts (e.g., different types of scenes, different environments, different weather conditions, different traffic conditions, different road conditions, different driving constraints, different scenarios, different driving intents, different environment conditions, different geographies, different use cases, etc.).

For example, a vehicle can use the systems and techniques described herein to turn or maintain on (or increase an operating mode, a data collection frequency, a sensor data resolution, a power mode, etc.) and use specific sensors to collect sensor data when the vehicle is in certain operational contexts, and turn or maintain off (or reduce an operating mode, a resource consumption, a power consumption, a data collection frequency, a sensor data resolution, a power mode, etc.) different sensors when the vehicle is in such operational contexts if the vehicle determines that the data from the different sensors are less or not accurate, less or not relevant, less or not valuable, less or not needed, etc., in such operational contexts and/or the vehicle determines that it can reduce or eliminate use of the sensor data from the different sensors when navigating in the operational contexts without negatively impacting (or with a minimal or acceptable impact on) the performance of the vehicle in such operational contexts.

By dynamically selecting and implementing sensor configurations based on the operational context of the vehicle, the systems and techniques described herein can reduce the overall power and/or resource consumption associated with the sensors used by the vehicle in the operational context. In other words, to reduce sensor power and/or resource consumption while maintaining an operating performance of the vehicle, the vehicle may selectively switch on/off sensors (or adjust their operating mode, such as their data collection, their resolution, their power mode, their sensing frequency, their sensor data volume, etc.) dynamically based on various factors such as, for example and without limitation, characteristics of an operational context of the vehicle, a driving intent associated with an operational context, the types of sensors on the vehicle (e.g., surround-view cameras, thermal cameras, visible-light cameras, far-field cameras, near-field cameras, zoom cameras, short and/or long range LIDARs, RADARs, time-of-flight sensors, inertial measurement units, ultrasonics, speedometers, light sensors, etc.), the positions of the sensors on/about the vehicle (e.g., front, rear, left side, right side, roof, interior, etc.), data associated with the vehicle and/or the operational contexts, among other factors.

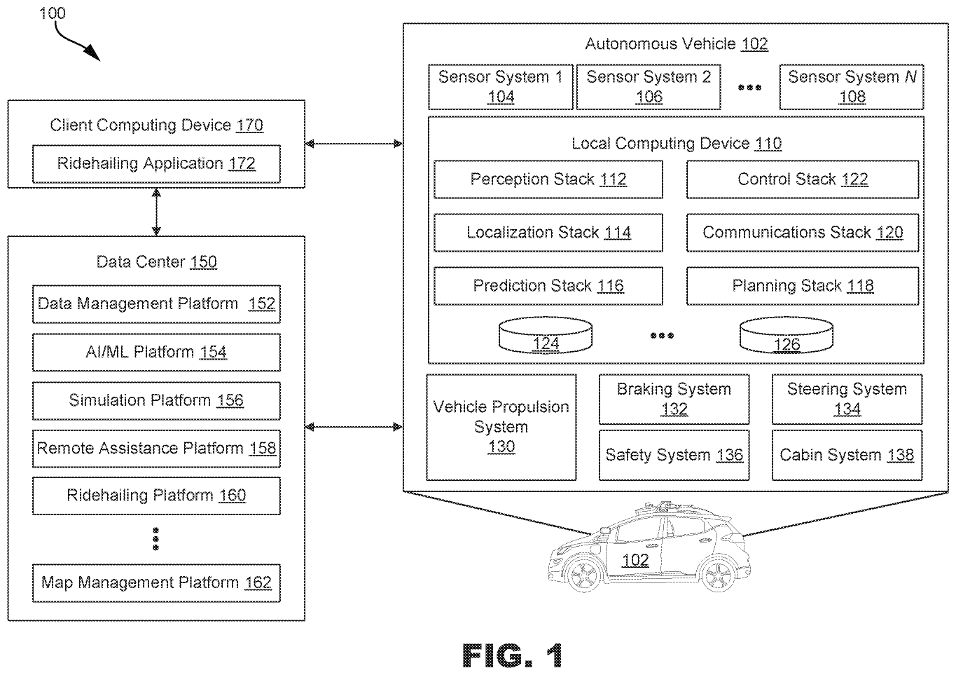

Various examples of the systems and techniques described herein are illustrated in FIG. 1 through FIG. 4 and described below.

FIG. 1 is a diagram illustrating an example autonomous vehicle (AV) environment 100, according to some examples of the present disclosure. One of ordinary skill in the art will understand that, for the AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by sensor systems 104, 106, and 108. The sensor systems 104-108 can include one or more types of sensors and can be arranged about the AV 102. For instance, the sensor systems 104-108 can include one or more Inertial Measurement Units (IMUs), LIDAR systems (e.g., long range LIDAR sensors, short range LIDAR sensors, medium range LIDAR sensors, higher-power LIDARs, etc.), cameras (e.g., still image cameras, video cameras, thermal cameras, surround view cameras, zoom cameras, wide-angle cameras, narrow-angle cameras, short range cameras, medium range cameras, long range cameras, etc.), light sensors (e.g., ambient light sensors, infrared sensors, time-of-flight (TOF) sensors, etc.), RADAR systems, GPS receivers, acoustic sensors (e.g., microphones, Sound Navigation and Ranging (SONAR) systems, ultrasonic sensors, etc.), accelerometers, gyroscopes, magnetometers, engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and/or the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and/or other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridehailing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridehailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridehailing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162 and/or a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridehailing platform 160 can interact with a customer of a ridesharing service via a ridehailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridehailing application 172. In some cases, the client computing device 170 can be a customer's mobile computing device or a computing device integrated with the AV 102 (e.g., the local computing device 110). The ridehailing platform 160 can receive requests to pick up or drop off from the ridehailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs (e.g., AV 102), Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridehailing platform 160 may incorporate the map viewing services into the ridehailing application 172 to enable passengers to view the AV 102 in transit to a pick-up or drop-off location, and so on.

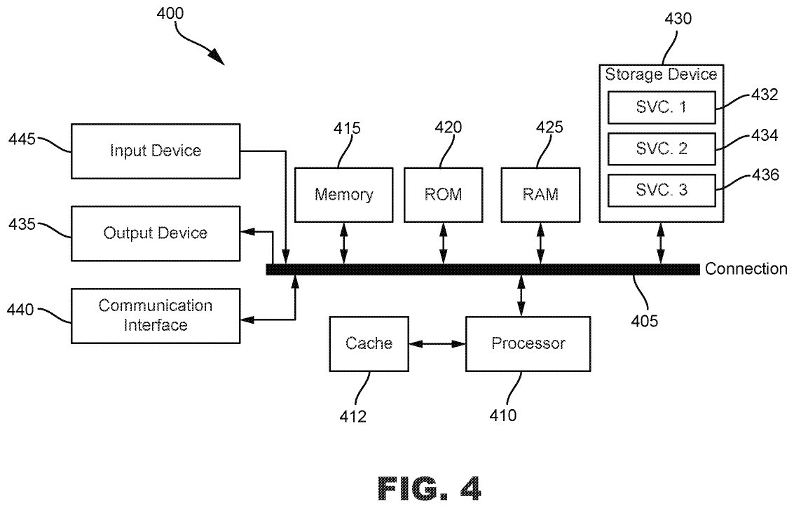

While the AV 102, the local computing device 110, and the AV environment 100 are shown to include certain systems and components, one of ordinary skill will appreciate that the AV 102, the local computing device 110, and/or the AV environment 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 4.

In some examples, the local computing device 110 of the AV 102 can include an ADSC. Moreover, the local computing device 110 can be configured to implement the systems and techniques described herein. For example, the local computing device 110 can be configured to implement the dynamic sensor configurations described herein.

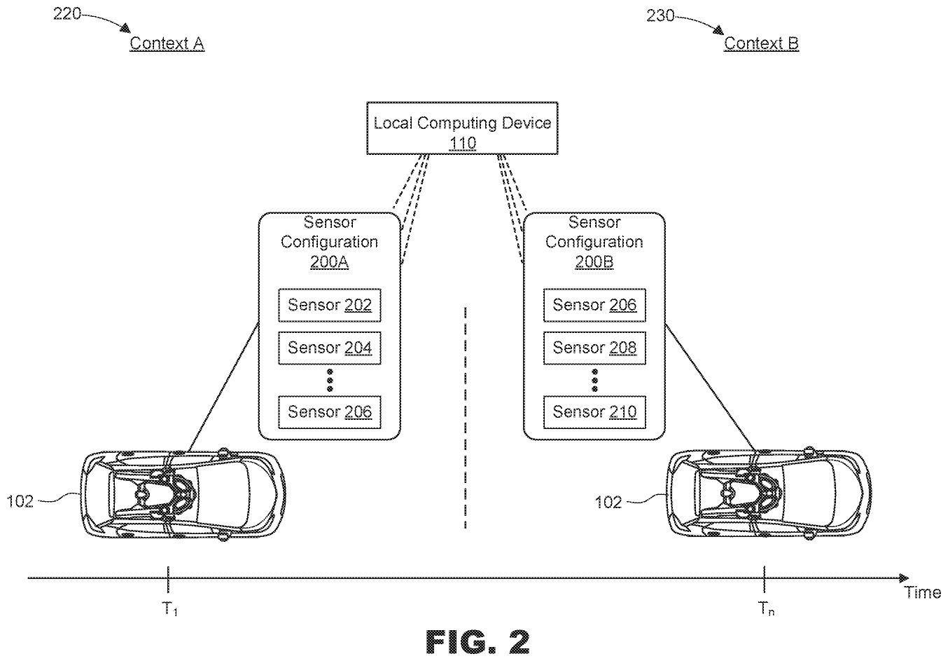

FIG. 2 is a diagram illustrating example vehicle sensor configurations (e.g., sensor configuration 200A, sensor configuration 200B) dynamically selected for different operational contexts of the AV 102, according to some examples of the present disclosure. As shown, the AV 102 can dynamically implement different sensor configurations (e.g., sensor configuration 200A, sensor configuration 200B) when the AV 102 operates in different operational contexts. For example, in FIG. 2, the AV 102 can dynamically select and implement sensor configuration 200A when the AV 102 is in the operational context 220, and sensor configuration 200B when the AV 102 is in the operational context 230. In this example, selecting and implementing sensor configuration 200A can include turning on any of the sensors 202, 204, and 206 that are turned off (if any) and using the sensors 202, 204, and 206 to collect sensor data when the AV 102 is in the operational context 220, while turning off or adjusting an operation mode of other sensors (e.g., sensors 208 and 210 and any other sensors) when the AV 102 is in the operational context 220. Similarly, selecting and implementing sensor configuration 200B can include turning on any of the sensors 206, 208, and 208 that are turned off (if any) and using the sensors 206, 208, and 210 to collect sensor data when the AV 102 is in the operational context 230, while also turning off or adjusting an operation mode of other sensors (e.g., sensors 202, 204, and any other sensors) when the AV 102 is in the operational context 230.

In some examples, adjusting an operation mode of a sensor (e.g., sensors 208 and 210 of the sensor configuration 200B when the AV 102 is in the operational context 220, any of the sensors 202-206 in the sensor configuration 200A that are in a reduced operating mode when using such sensors in the operational context 220, sensors 202 and 204 in the sensor configuration 200B when the AV 102 is in the operational context 230, or any of the sensors 206-210 in the sensor configuration 200B that are in a reduced operating mode when using such sensors in the operational context 230) can include increasing or decreasing an operating frequency (e.g., a data collection frequency) of the sensor, increasing or decreasing a resolution of the sensor, increasing or decreasing a framerate of the sensor, increasing or decreasing a power mode of the sensor, turning on or off one or more features (e.g., functionalities, capabilities, enhancements, processing settings, one or more tasks/functions, one or more hardware and/or software components and/or modules, etc.) of the sensor, changing one or more parameters/settings of the sensor, and/or making any other changes to the operation of the sensor and/or the collection of associated data (and/or features of the collected sensor data) that can impact a power and/or resource consumption associated with the sensor and/or the data from the sensor.

For example, adjusting the operation of the sensors 202-206 selected for use in the sensor configuration when the AV 102 is in the operational context 220 can include increasing an operating frequency (e.g., a data collection frequency) of any of the sensors 202-206 that are in a lower operating frequency, increasing a resolution of any of the sensors 202-206 that are operating in a reduced resolution, increasing a framerate of any of the sensors 202-206 that are operating with a reduced framerate, increasing a power mode of any of the sensors 202-206 that are operating in a reduced or lower power mode, turning on one or more features of any of the sensors 202-206 that are turned off, etc. Moreover, adjusting the operation of other sensors (e.g., sensors 208 and 210) that are not selected for use in the sensor configuration when the AV 102 is in the operational context 220 can include turning off or powering down such sensors, decreasing an operating frequency (e.g., a data collection frequency) of the sensors, decreasing a resolution of the sensors, decreasing a framerate of the sensors, decreasing a power mode of the sensors (e.g., setting the sensors to a lower power mode, setting the sensors to sleep or hibernation mode, turning off the sensors, etc.), turning off one or more features of the sensors, etc. In other words, adjusting the operation of sensors selected for use in a sensor configuration can include turning on the sensors and/or adjusting anything about the data captured by such sensors that can improve the data and/or adjusting anything about the operation of such sensors that can increase a performance, quality, accuracy, and/or operation of such sensors, and adjusting the operation of sensors that are not selected for use in a sensor configuration can include adjusting anything about the data captured by such sensors that can improve the data and/or adjusting anything about the operation of such sensors that can reduce a power and/or resource consumption of such sensors.

The AV 102 can select the sensor configuration 200A (e.g., turning/maintaining on and using sensors 202, 204, and 206 when the AV 102 is in the operational context 220) based on one or more factors such as, for example and without limitation, characteristics of the operational context 220 (e.g., conditions, setting, attributes, events, constraints/restrictions, operational demands, weather, geography, etc.); any data and/or operational needs, constraints, and/or considerations associated with the operational context 220; capabilities of the AV 102; data, capabilities, and/or considerations associated with the sensors 202, 204, and 206; power and/or computer resource constraints, capabilities, and/or considerations of the AV 102; power and/or compute resource states and/or demands at the AV 102; among other factors. Similarly, the AV 102 can select the sensor configuration 200B (e.g., turning/maintaining on and using sensors 206, 208, and 210 when the AV 102 is in the operational context 230) can be based on one or more factors as described herein.

In some examples, when the AV 102 is in the operational context 220 and using sensors 202, 204, and 206 according to sensor configuration 200A, the AV 102 can adjust a power usage and/or operation of sensors 208 and 210, and when the AV 102 is in the operational context 230 and using sensors 206, 208, and 210 according to sensor configuration 200B, the AV 102 can adjust a power usage and/or operation of sensors 202 and 204. For example, when the AV 102 is in the operational context 220, the AV 102 can turn off or reduce one or more data capture operations of the sensors 208 and 210 (e.g., turn off data collection of the sensors 208 and 210 or set the sensors 208 and 210 to collect less data than in other operational contexts such as operational context 230) and/or turn off or reduce a power mode of (e.g., reduce a power usage of) sensors 208 and 210, and when the AV 102 is in the operational context 230, the AV 102 can turn off or reduce one or more data capture operations of the sensors 202 and 204 (e.g., turn off data collection of the sensors 202 and 204, or set the sensors 202 and 204 to collect less data than in other operational contexts such as operational context 220) and/or turn off or reduce a power mode of (e.g., reduce a power usage of) sensors 202 and 204.

In some examples, each operational context (e.g., operational context 220 and operational context 230) can include, for example and without limitation, a type of road (e.g., a single lane road, a multi-lane road, a highway, an urban environment/street(s), an ingress or egress ramp, etc.), a road condition(s) (e.g., a roadway grade, a road curvature, a road surface condition, a road with unfinished construction/repairs, a road with a pothole(s), a road with one or more obstacles, an unpaved road, a paved road, a road with precipitation accumulation (e.g., wet, snowy, icy, muddy, etc.), a road with road salt, a road with or without (or with missing or degraded) markings, a road at least partly covered with or having a layer(s) of particles (e.g., dust, sand, gravel, sediment, mud, plant matter such as grass, etc.), certain traffic conditions (e.g., more or less than a threshold amount of traffic/congestion, etc.) and/or traffic patterns, a type of scene/environment and/or navigation zone (e.g., a rural environment, an urban environment, a highway environment, a school zone, a construction zone, a parking lot, a garage, a detour zone, a temporary navigation zone guided with temporary navigation objects and/or signs such as traffic cones, etc.), ambient light and/or visibility conditions (e.g., nighttime conditions with reduced light/visibility, daylight conditions with more than a threshold amount of light/brightness levels, environments having above a threshold amount/level of darkness (e.g., reduced light/brightness levels that are below a threshold), obstructed visibility (e.g., caused by fog, an object(s), a tree, a building, etc.), etc.), weather conditions (e.g., precipitation conditions (e.g., rain, snow, sleet, ice, hail, fog, etc.), dry conditions, sunlight conditions, cloudy or partly cloudy conditions, wind speeds and/or wind gust conditions, fog, etc.), operational constraints and/or conditions (e.g., speed limits, vehicle passing constraints or restrictions, maneuverability constraints, spatial constraints, navigation constraints, traffic rules, etc.), geographic scenarios (e.g., wet environments, dry environments, mountainous regions, flat regions, bridges, hills, etc.), scene elements (e.g., traffic lights, stop signs, crosswalks, intersections, merge lanes/areas, etc.), driving/road obstacles (e.g., potholes, road side parking, pedestrians, objects, etc.), and/or a vehicle maneuver/driving intent (e.g., a planned/intended u-turn, lane merge, acceleration, deceleration, turn, crossing of an intersection and/or crosswalk, lane switching, reversing maneuver, braking maneuver, stopping maneuver, parking maneuver, any other maneuver, reroute, etc.), among others.

The operational contexts (e.g., operational context 220 and operational context 230) can differ based on one or more factors such as, for example and without limitation, road types and/or conditions (e.g., single lane roads, multi-lane roads, highways, urban streets, road surface conditions, etc.), traffic conditions and/or patterns, types of scenes/environments and/or navigation zones (e.g., rural environment, urban environment, highway environment, school zones, construction zones, parking lots, garages, etc.), ambient light and/or visibility conditions (e.g., darker versus brighter conditions, etc.), weather conditions (e.g., rain, snow, sleet, dry, sunny, wind speeds and wind gust conditions, fog, etc.), operational constraints and/or conditions (e.g., speed limits, passing constraints, navigation constraints, traffic rules, etc.), geographic conditions (e.g., roadway grade, road curvatures, wet environments, dry environments, mountainous regions, flat regions, bridges, etc.), scene elements (e.g., traffic lights, stop signs, crosswalks, intersections, merge lanes/areas, etc.), driving/road obstacles (e.g., potholes, road side parking, pedestrians, objects, etc.), etc.

For example, in some cases, the operational context 220 may have less traffic than the operational context 230 (or vice versa), the operational context 220 may be an urban setting while the operational context 230 may include a rural setting or a freeway/highway setting (or vice versa), the operational context 220 may have more ambient light than the operational context 230 (e.g., a sunny day versus a nighttime or cloudy environment, etc.), and/or the operational context 220 may include a construction or school zone while the operational context 230 may not (or vice versa). Other example differences between operational contexts (e.g., operational context 220 and operational context 230) can include, but are not limited to, certain weather conditions (e.g., precipitation such as rain, snow, fog, hail, ice, etc.), operational needs (e.g., parking, traversing intersections, merging lanes, traversing highways, traversing urban environments, traversing environments with certain levels/amounts of traffic, driving in a single lane road or a multi-lane road, navigating environments with crosswalks and/or pedestrians, navigating construction zones, making turns, stopping at certain points, driving at certain speeds (e.g., speeds higher than a threshold or lower than a threshold), changing lanes, performing certain vehicle maneuvers, etc.

The AV 102 can use one or more types of data and/or data from one or more sources to dynamically determine which sensor configuration (e.g., sensor configuration 200A or sensor configuration 200B) to implement in a given operational context (e.g., operational context 220, operational context 230) such as, for example and without limitation, map data (e.g., HD maps stored in geospatial database 126), route planning data (e.g., data from the planning stack 118 such as planned routes, planned maneuvers, etc.), environmental data, perception data (e.g., data from the perception stack 112 such as object detection data, object recognition data, scene detection data, event and/or condition detection data, scene element detection data, etc.), prediction data (e.g., data from the prediction stack 116 such as data predicting a behavior, trajectory, and/or characteristic of a vehicle, an object, a pedestrian, etc.), vehicle speed data, location data (e.g., data from the localization stack 114 such as a tracked location), weather data, traffic data, event data, information about a planned route, information about an area along a planned route and/or including the planned route, and/or sensor data (e.g., from any of the sensors 202 through 210), among others.

Each of the sensors 202 through 210 can include any type of sensor on the AV 102 such as, for example and without limitation, an IMU, a LIDAR (e.g., a long range LIDAR, a short range LIDAR, a medium range LIDAR, a higher-power LIDAR, a lower-power LIDAR, etc.), a camera (e.g., a still image camera, a video camera, a thermal camera, a surround-view camera, a zoom camera, a wide-angle camera, a narrow-angle camera, a short-range camera, a medium-range camera, a long-range camera, etc.), a light sensor (e.g., an ambient light sensor, an infrared sensor, etc.), a TOF sensor, a RADAR, a GPS receiver, an acoustic sensor (e.g., a microphone, a SONAR system, an ultrasonic sensor, etc.), an accelerometer, a gyroscope, a magnetometer, a speedometer, a tachometer, an altimeter, a tilt sensor, an impact sensor, a rain sensor, and so forth. For example, in some cases, the sensor 202 can be a camera system, the sensor 204 can be a LIDAR system, the sensor 206 can be a RADAR system, the sensor 208 can be an ultrasonic sensor, and the sensor 210 can be a TOF sensor. Other example sensors and/or sensor configurations may include any other number and/or type of sensors. Moreover, the sensors 202-210 can be positioned at respective locations within/on/about the AV 102, such as a roof of the AV 102, a front (e.g., front center, front left (e.g., driver side), a front right (e.g., passenger side), etc.) of the AV 102, a rear (e.g., rear center, rear left, rear right, etc.) of the AV 102, a side of the AV 102 (e.g., left side, right side, etc.), an interior of the AV 102, etc. The positioning of each sensor can impact the visibility, field-of-view, angle, and/or sensing performance/operation of the sensor, and can thus be taken into account when selecting a sensor configuration, as further described herein.

Under certain operational contexts (e.g., operational context 220, operational context 230), the AV 102 may selectively engage/disengage and/or adjust an operation of (e.g., turn off, turn on, adjust a power mode, adjust sensor operations, etc.) one or more sensors of the AV 102 dynamically as part of a selected sensor configuration (e.g., sensor configuration 200A, sensor configuration 200B), depending on, for example, the operational context, the types of sensors on the AV 102 (e.g., cameras, LIDARs, RADARs, ultrasonics, speedometers, TOF sensors, etc.), the position of sensors on/about the AV 102 (e.g., a front of the AV 102, a rear of the AV 102, a left side of the AV 102, a right side of the AV 102, a top side or roof of the AV 102, inside of the AV 102, etc.), sensor data, perception data (e.g., data from perception stack 112), location information (e.g., localization data from localization stack 114), vehicle speed information, prediction data (e.g., data from prediction stack 116), route planning data (e.g., data from planning stack 118), map data, traffic data, weather data, operational constraints, operational needs, etc.

For example, assume that the operational context 220 represents an urban environment during daytime hours and has a threshold amount of ambient light, and the operational context 230 represents a highway/freeway environment during nighttime hours and less than a threshold amount of ambient light. In the operational context 220 in this example, the AV 102 may need to maintain a lower traveling speed in the urban environment than in the highway/freeway environment of the operational context 230, may not need to use thermal cameras given the amount of ambient light in the environment, and may need to focus more on objects and activity within a closer proximity to the AV 102 than in the operational context 230 (e.g., because in the urban environment the AV 102 may need to travel at a lower speed than in the highway/freeway environment and may be more likely to encounter obstacles such as pedestrians than in the highway/freeway environment). In this example, the AV 102 may have less need or no need for data from thermal cameras on the AV 102 and may have a greater need than in the operational context 230 for data from near-field sensors (e.g., LIDARs having less than a threshold range and/or having a higher resolution than other LIDARs for distances within a threshold range, ultrasonic sensors which may have less than a threshold range and/or higher resolution for distances within a threshold range, etc.) that provide information about regions in a scene that are within a threshold distance to the AV 102 (e.g., shorter field visibility than other sensors). Moreover, in the operational context 220, the AV 102 may need data about a greater portion of the surroundings of the AV 102 than in the operational context 230 (e.g., because the AV 102 may need to travel slower in the operational context 220, may be more likely to encounter more obstacles such as pedestrians from different directions relative to the AV 102, may need to perform more maneuvers and/or maneuver within smaller spaces and/or shorter distances, etc.) and thus may benefit from data collected by one or more surround view cameras (e.g., 360-degree surround view cameras, etc.) of the AV 102.

Accordingly, in this example, the AV 102 may dynamically select a sensor configuration, which can include engaging (or maintaining use of) one or more of the near-field sensors and one or more surround-view cameras to collect data for use by the AV 102 to navigate the operational context 220. Since the operational context includes daylight hours and has a certain amount of ambient light, the AV 102 may determine that data from thermal cameras is unnecessary (or has less use/value) and may thus turn off one or more thermal cameras on the AV 102 or adjust their operation to stop or reduce data collection, reduce their power consumption, and/or otherwise reduce their resource consumption. In some cases, since longer-range information may not be necessary (or may have less value/use) in the operational context 220 (e.g., because the operational context 220 includes an urban environment and navigating such environment may involve focusing on the surroundings of the AV 102 that are closer to the AV 102 as compared with other environments such as highway environments which may involve focusing on objects that are farther away from the AV 102), the AV 102 may also turn off one or more far-field sensors (e.g., sensors having a sensing distance range above a threshold) or adjust their operation to stop or reduce data collection, reduce their power consumption, and/or otherwise reduce their resource consumption.

To illustrate, in the operational context 220, the AV 102 may dynamically select and implement a sensor configuration (e.g., sensor configuration 200A) that includes use of a near-field LIDAR (e.g., sensor 202), a surround-view camera (e.g., sensor 204), and a RADAR (e.g., sensor 206), while turning off a far-field LIDAR or camera (e.g., sensor 208) and a thermal camera (e.g., sensor 210) or adjusting their operation to reduce their power and/or resource consumption. This way, the AV 102 can reduce the overall power and resource consumption of sensors on the AV 102 by selecting a sensor configuration that reduces the amount of sensors used in the operational context 220 and/or reduces a usage, power consumption, and/or resource consumption of certain sensors that the AV 102 can turn off or adjust (e.g., adjust their operation to reduce their power and/or resource consumption) without a negative impact on the performance of the AV 102 in the operational context 220 (or with a minimal or acceptable impact on the performance of the AV 102 in the operational context 220).

In the example of the operational context 230 above that includes a highway/freeway environment at nighttime hours, the AV 102 may need to travel faster than in the operational context 220, may need to implement nighttime sensing capabilities, and may involve sensing objects and conditions that are farther from the AV 102 than in the operational context 220. For example, while traveling on the highway/freeway environment at nighttime, the AV 102 may have a need (or more need) for data from a thermal camera and one or more far-field sensors (e.g., sensors having a sensing distance range above a threshold) such as far-field LIDARs, RADARS, TOF sensors, etc., to detect/measure objects, events, and/or conditions that are farther away from the AV 102. Moreover, the AV 102 may have more need for sensors positioned to capture data for regions in front of the AV 102 and less need for sensors positioned to capture data for regions behind the AV 102. Thus, in this example, the AV 102 may select a sensor configuration (e.g., sensor configuration 200B) for the operational context 230 that includes engaging (or maintaining use of) a front-facing RADAR (e.g., sensor 206), a front-facing far-field LIDAR (e.g., sensor 208), and a thermal camera (e.g., sensor 210).

Since near-field sensors and surround-view cameras may not be needed in the operational context 230 (or can be turned off or adjusted to reduce their power and/or resource consumption without a negative performance impact or a minimal/acceptable performance impact), the sensor configuration selected by the AV 102 for the operational context 230 may include turning off one or more near-field sensors (e.g., sensor 202) and one or more surround-view cameras (e.g., sensor 204) or adjusting their operation mode to reduce their data collection, power consumption, and/or resource consumption). In this example, the AV 102 can thus dynamically select the configuration that includes using the sensors 206, 208, and 210 to assist the AV 102 in navigating the highway/freeway environment at nighttime. In some examples, the sensor configuration selected for the operational context 230 can include turning off (or adjusting their operation) other sensors that the AV 102 determines it can turn off (or adjust their operation) without a negative performance impact (or with a minimal or acceptable impact), such as one or more rear-facing sensors, an ultrasonic sensor, etc.

In another example, assume that the operational context 220 represents a vehicle intent that includes making an unprotected left turn (e.g., a left turn that crosses a path of incoming traffic) in an intersection. In other words, in this scenario, the AV 102 intends to make the unprotected left turn that crosses a path of any vehicles that may be potentially traveling in an opposite direction (e.g., relative to the direction of the road the AV 102 intends to turn into). Thus, the AV 102 may select a sensor configuration that includes using certain sensors that provide information about regions of the scene that are within the path of the AV 102 throughout the left turn maneuver, as well as regions of the scene within the path of any pedestrians and/or within the path of any vehicles that may be potentially traveling in the opposite direction.

For example, in this example scenario, the AV 102 may turn on (or maintain on) one or more sensors on the AV 102 that is/are facing in the direction of travel of the AV 102 (and/or having a field-of-view that includes the path of the AV 102), one or more sensors on the AV 102 facing the path/direction of any vehicles that may potentially cross a path of the AV 102 (and/or have a field-of-view that includes the path of such vehicles), and/or one or more sensors capable of detecting any pedestrians crossing a portion of the intersection, such as a set of left-facing and front-facing sensors (e.g., left and front facing relative to a direction of travel of the AV 102), but may turn off one or more rear-facing sensors (or adjust their operation to reduce their data collection, power consumption, and/or resource consumption). In some examples, in this context, the sensor configuration selected by the AV 102 can include one or more short-field sensors (e.g., short-range LIDARs, ultrasonics, etc.) and optionally one or more far-field sensors (e.g., long-range LIDARs, long-range cameras and/or TOF sensors, RADARs, etc.), as the short-field sensors and the far-field sensors can both obtain relevant measurements (e.g., speed, distance/range, trajectory, location, shape, size, object type, heading, etc.) of any approaching and/or proximal/surrounding (e.g., within a distance relative to the AV 102 and/or a projected path of the AV 102) vehicles, pedestrians, motorcycles, bicycles, animals, objects, scene elements, etc. The sensors in the selected sensor configuration can provide different, corroborating, and/or relevant information about the environment and the operational context (e.g., the example operational context 230), which the AV 102 can use to assist the AV 102 in performing the left turn in such an operational context, while reducing the data collection, power consumption, and/or resource consumption of other sensors that may provide less relevant, less accurate, and/or unnecessary information.

For instance, surround-view cameras can monitor intersection traffic (e.g., vehicle and pedestrian traffic, etc.) traveling in different directions and/or located in different regions within the scene, and short-range sensors can provide information about anything within a proximity to the AV 102 and/or a projected path of the AV 102, both of which can be used to assist the AV 102 in performing the left turn while avoiding any traffic and obstacles along the way. In this example, the AV 102 may turn on (or maintain on) one or more front-facing and left-facing (e.g., relative to a direction of the AV 102) sensors (e.g., LIDARs, cameras, RADARs, TOF sensors, etc.), one or more short-range sensors (e.g., one or more ultrasonic sensors, short-range LIDARs, short-range cameras, short-range TOFs, etc.), one or more surround-view cameras, and/or one or more long-range sensors (e.g., one or more long-range LIDARs, long-range cameras, long-range TOFs, etc.), which the AV 102 can use to monitor the path of the AV 102 and any objects/obstacles that may cross a path of the AV 102 (or may be within a threshold range of the AV 102 at any given time when the AV 102 intends to traverse such path).

In another example, the AV 102 may adapt a sensor configuration for driving in certain weather conditions. For instance, if the operational context 220 includes a driving environment with a certain amount of fog, the AV 102 may select a sensor configuration that includes sensors that perform better in fog conditions than other sensors of the AV 102, and turn off one or more sensors that may not perform as well in fog conditions and/or that may be deemed unnecessary or less helpful in fog conditions. For example, if the AV 102 determines that higher-power LIDARs, RADARs and longwave infrared cameras perform well in fog conditions and visible light cameras perform poorly in fog conditions, the AV 102 can select a sensor configuration that includes using one or more higher-power LIDARs, RADARs, and longwave infrared cameras to collect data in the fog conditions, while turning off (or adjusting a data collection, power consumption, and/or resource consumption) of one or more visible-light cameras to maximize sensor performance (e.g., increase/enhance sensor visibility and/or measurements in the fog conditions) while reducing power and/or resource consumption of visible-light cameras when operating in the fog conditions.

In some examples, the AV 102 can determine the operational context that the AV 102 is located in and/or intends to navigate (e.g., operational context 220, operational context 230) and/or any characteristics of the operational context based on map data, route/planning data (e.g., from the planning stack 118), traffic data, weather data, vehicle speed data, sensor data, tracking data, and/or any other relevant data. For example, the AV 102 can use route/planning data to determine a route and any potential maneuvers of the AV 102, map data to determine information about the driving environment along the route, traffic and/or weather data to determine conditions in the driving environment, and sensor data to detect any objects/obstacles, events, activity, conditions, scene elements, environmental and/or road attributes, and/or other contextual details associated with the AV 102 and the operational context. The AV 102 can use this information and information about the types, performance, use, and/or capabilities of sensors on the AV 102, to dynamically determine what sensors may provide the most relevant, useful/valuable, and/or accurate information in such an operational context, and what sensors (if any) may provide information that is less relevant (or irrelevant), less useful/valuable (or not useful/valuable), and/or less accurate information in such an operational context (and/or which sensors can be turned off or adjusted without a negative impact (or a minimal or acceptable impact) on an ability of the AV 102 to sense the environment in the operational context and navigate in the operational context, and/or what sensors are deemed to be necessary or unnecessary in the operational context.

The AV 102 can use such information/determinations to dynamically select a sensor configuration for the operational context, which can include selecting which sensors to turn/maintain on, turn/maintain off, adjust (e.g., to increase or reduce their data collection, power consumption, and/or resource consumption; to operate in a higher-operating mode (e.g., a higher-power mode, a higher-frequency of operation, a higher-resolution mode, etc.) or a lower-operating mode (e.g., a lower-power mode, a lower-frequency of operation, a lower-resolution mode, etc.); etc. The AV 102 can then dynamically implement the sensor configuration for the operational context, which can aim to reduce power and resource consumption from one or more sensors that are turned off, adjusted, or operated in a lower-operating mode in the operational context, without negatively impacting the performance of the AV 102 in the operational context (or with a minimal or acceptable negative impact). If the AV 102 subsequently encounters a different operational context, the AV 102 can similarly select a sensor configuration for the different operational context and dynamically switch from a sensor configuration selected for the previous operational context to the sensor configuration selected for the different operational context.

For example, assume that the AV 102 is in an operational context that involves traveling at speeds above a threshold and, when in such operational context, the AV 102 has a need to detect longer-range objects (e.g., objects located above a threshold distance away from the AV 102) and thus has selected (and implemented) a sensor configuration for the operational context that includes a set of sensors determined to perform well for longer-range sensing (e.g., relative to other sensors of the AV 102). If the AV 102 subsequently detects (e.g., using a sensor such as a speedometer, an accelerometer, an IMU, etc.) a threshold reduction in speed for a threshold amount of time, the AV 102 can determine that the AV 102 is now in a different operational context where the AV 102 needs to travel at a lower speed and has a greater need to detect shorter-range objects than in the previous operational context, the AV 102 can dynamically switch to a different sensor configuration selected for the different operational context. The different sensor configuration can include, for example, a set of sensors determined to be better suited for shorter-range sensing such as, for example and without limitation, one or more ultrasonics, near-field cameras, near-field LIDARs, RADARs, etc. With the different sensor configuration, the AV 102 may turn off one or more sensors that are better suited for longer-range sensing or adjust their operation in a way that reduces their power and/or resource consumption. In this way, the AV 102 can dynamically implement different sensor configurations for different operational contexts and reduce the power and/or resource consumption of sensors on the AV 102 by intelligently turning off or adjusting an operating mode (e.g., lowering a power mode, lowering a compute resource demand by adjusting one or more sensor operations/states, etc.) of certain sensors when the AV 102 is in a particular operational context and where such sensors are determined to be less suitable for the particular operational context.

As previously noted, the AV 102 can dynamically decide which sensors to use (or increase a use and/or an operating mode of) and what sensors not to use (or what sensors to turn off or reduce a use and/or operating mode of) in a given operational context of the AV 102 based at least in part on the capabilities of the sensors on the AV 102, any advantages and/or disadvantages of such sensors, the type of data/measurements provided by such sensors, the type of sensor data needed or desired in any given operational context, an intent of the AV 102 in the operational context, characteristics of the operational context, environmental factors, other contextual factors, and/or characteristics of the sensor data from such sensors, among other things. In some examples, the AV 102 can additionally or alternatively decide which sensors to use (or increase a use and/or an operating mode of) and what sensors not to use (or what sensors to turn off or reduce a use and/or operating mode of) in the given operational context of the AV 102 based on the positions of the sensors on/about/within the AV 102 and/or the field-of-views of the sensors from their respective positions. For example, the position of a sensor can impact what areas in space (e.g., relative to the sensor) can be sensed/measured by the sensor and/or the field-of-view and/or visibility of the sensor. Thus, some sensors may be more relevant than others in a given operational context, at least in part as a result of their position on/about/within the AV 102. Accordingly, the AV 102 can take into account the positions of sensors (and/or associated field-of-views) when deciding which sensors to use (or increase a use and/or an operating mode of) and what sensors not to use (or what sensors to turn off or reduce a use and/or operating mode of) in the given operational context of the AV 102.

For example, while a thermal camera can be generally useful to the AV 102 when the AV 102 operates at nighttime (and/or in any other environments having less than a threshold amount of light/brightness levels), such thermal camera may be less useful if the thermal camera is positioned on a side of the AV 102 and pointed away from the AV 102 in a left direction (e.g., relative to a forward position and/or traveling direction of the AV 102) if the AV 102 is driving forward in a single-lane highway at night, as the AV 102 may have a lower need to sense things located along a plane(s) extending from the side of the AV 102 (e.g., the AV 102 has a greater need to sense things in front of the AV 102). Thus, in such cases, despite the thermal camera being generally useful/valuable when operating at night, the AV 102 may decide to turn off the thermal camera (or reduce an operating mode of the thermal camera such as a data collection frequency, a resolution, a feature/functionality, a power mode, etc.) when the AV 102 is traveling forward in the single-lane highway at night, as the AV 102 may determine that, in such an operational context, the value, relevance, accuracy, and/or need for camera data captured while the thermal camera is on the side of the AV 102 and pointed away from the side of the AV 102 is outweighed by the power and/or resource reduction benefits from turning off the thermal camera or otherwise reducing its operating mode.

As another example, if the AV 102 is reversing into a parking space, the AV 102 may have less need to sense things in front of the AV 102 (e.g., opposite to the direction of travel of the AV 102 when reversing). As such, in this example, the AV 102 may decide to turn off a sensor positioned on a front of the AV 102 and/or pointing towards a front of the AV 102 (or reduce an operating mode of the sensor such as a data collection frequency, a resolution, a feature/functionality, a power mode, etc.) to reduce a power and/or resource consumption by the sensor if such sensor is otherwise turned/maintained on (or its operating mode increased). Here, the AV 102 may determine that the use, value, relevance, accuracy, and/or need for data from such sensor is outweighed by the power and/or resource reduction benefits from turning off the sensor or otherwise reducing its operating mode.

In some cases, to select a sensor configuration for an operational context, the AV 102 can balance various factors in determining a sensor configuration (e.g., in determining which sensors to turn on/off or adjust an operation of) for an operational context. For example, the AV 102 can balance power needs of sensors, resource needs of sensors, power and/or resource needs of other software/hardware components, power and resource capabilities of the AV 102 (and the local computing device 110 of the AV 102), battery charge levels of the AV 102, a complexity and/or risk (and/or risk severity) associated with the operational context, data needs for the operational context, and/or any of the other factors described above. For example, if the battery charge levels of the AV 102 and/or the availability of compute resources at the AV 102 are above a threshold, the AV 102 can apply a reduced weight to any factors that can weigh against selecting (and using) one or more sensors for a sensor configuration associated with the operational context. On the other hand, if the battery charge levels of the AV 102 and/or the availability of compute resources at the AV 102 are below a threshold, the AV 102 can apply an increased weight to such factors to increase the likelihood that such sensors are not selected (or used) for a sensor configuration associated with the operational context.

To illustrate, if the battery charge levels of the AV 102 and/or the availability of compute resources at the AV 102 are above a threshold, the AV 102 may be more willing to select and use one or more sensors that could otherwise be turned off in the operational context, and thus may reduce a weight of any factors that work against their selection and use in the operational context to increase the likelihood that such sensors are selected and used for the operational context since the AV 102 has sufficient battery charge levels and computer resource levels to spare for use by such sensors. If the battery charge levels of the AV 102 and/or the availability of compute resources at the AV 102 are otherwise below a threshold, the AV 102 may be less willing to select and use one or more sensors that could otherwise be turned off in the operational context, and thus may increase a weight of any factors that work against their selection and use in the operational context to decrease the likelihood that such sensors are selected and used for the operational context since the AV 102 has more limited battery charge levels and/or computer resource levels.

As another example, if the complexity of the operational context is above a threshold, the AV 102 may increase a weight applied to certain sensors that would otherwise have a likelihood of being deselected for the operational context, in order to increase the likelihood of selecting such sensors as the additional sensor data from such sensors may have some use/value in such a complex operational context. On the other hand, if the complexity of the operational context is below a threshold, the AV 102 may decrease a weight applied to certain sensors in order to decrease the likelihood of selecting such sensors as the need for data from such sensors may be outweighed by the power and/or resource preservation needs of the AV 102 given the lower complexity operational context.

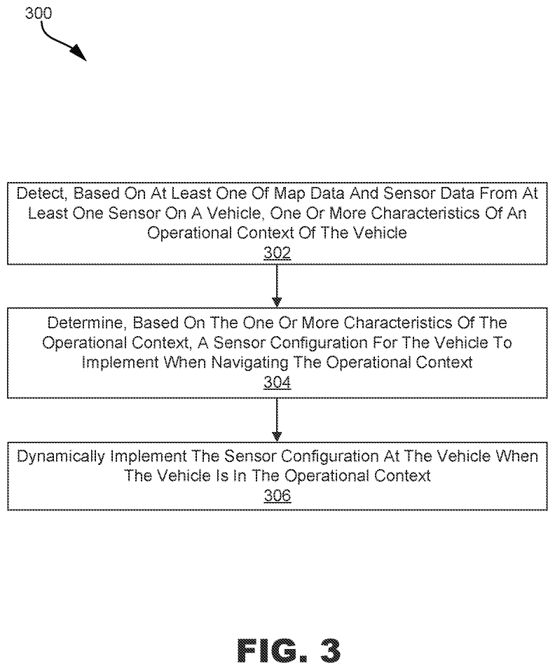

FIG. 3 is a flowchart illustrating an example process 300 for dynamically implementing vehicle sensor configurations (e.g., sensor configuration 200A, sensor configuration 200B) based on operational contexts, according to some examples of the present disclosure. At block 302, the process 300 can include detecting, based on map data and/or sensor data from at least one sensor (e.g., sensor system 104, sensor system 106, sensor system 108) on a vehicle (e.g., AV 102), one or more characteristics of an operational context of the vehicle.

In some cases, the at least one sensor on the vehicle can include a visible-light camera sensor, a RADAR sensor, a TOF sensor, a LIDAR sensor, a thermal camera sensor, a speedometer, an IMU, and/or an ultrasonic sensor.

In some examples, the sensor data from at least one sensor on the vehicle can include a speed measurement associated with the vehicle, a measurement of a heading of the vehicle, image data (e.g., a still image, a video, etc.), a distance or range measurement of one or more objects in a scene of the vehicle, a motion measurement of the one or more objects in the scene, and/or a measured trajectory of the vehicle and/or the one or more objects in the scene.

In some cases, the operational context and/or the one or more characteristics of the operational context can include a type of a driving environment (e.g., an urban environment, a rural environment, a highway environment, a garage, a parking lot, a suburban environment, a school zone, a construction zone, a city street, an airport region, etc.) associated with the vehicle, a driving intent of the vehicle (e.g., perform a turn, cross an intersection and/or crosswalk area, reverse, change lanes, merge lanes, enter an egress or ingress ramp, drive forward, accelerate, decelerate, park, make a u-turn, yield to other traffic, etc.), a weather (e.g., snow, ice, rain, wind, etc.) associated with the driving environment, a light or brightness level (e.g., ambient light levels, daytime brightness levels, nighttime darkness levels, etc.) in the driving environment, traffic conditions in the driving environment, a traffic rule associated with the driving environment, a type of road (e.g., highway, single lane road, multi-lane road, a dirt road, one-way road, bidirectional road, temporary construction detour road, highway ramp, city street, etc.) associated with the driving environment, and/or a geography (e.g., a mountain region, a flat region, a topography, a hill, a bridge, etc.) associated with the driving environment.

At block 304, the process 300 can include determining, based on the one or more characteristics of the operational context, a sensor configuration (e.g., sensor configuration 200A, sensor configuration 200B) for the vehicle to implement when navigating the operational context. In some examples, the sensor configuration can include one or more sensors (e.g., sensors 202-206 in sensor configuration 200A, sensors 206-210 in sensor configuration 200B) selected for use by the vehicle in the operational context and one or more different sensors set to an off state (e.g., turned off) or a reduced operating mode while the vehicle is in the operational context.

In some cases, the one or more sensors in the sensor configuration can include a visible-light camera sensor, a RADAR sensor, a TOF sensor, a speedometer, an IMU, a LIDAR sensor, a thermal camera sensor, and/or an ultrasonic sensor.

At block 306, the process 300 can include dynamically implementing the sensor configuration at the vehicle when the vehicle is in the operational context. In some examples, dynamically implementing the sensor configuration at the vehicle when the vehicle is in the operational context can include configuring the one or more sensors to run and collect sensor data while the vehicle is in the operational context and either turning off the one or more different sensors or configuring the one or more different sensors to operate in the reduced operating mode while the vehicle is in the operational context.

In some examples, the one or more different sensors in the sensor configuration are set to the reduce operating mode, and the reduced operating mode can include a reduced data collection frequency relative to a different data collection frequency of the one or more different sensors, a reduced power mode relative to a different power mode of the one or more different sensors, a reduced resolution relative to a different resolution of the one or more different sensors, a reduced framerate relative to a different framerate of the one or more different sensors, and/or a setting configured to reduce a resource consumption by the one or more different sensors.

In some examples, the one or more sensors in the sensor configuration can include a set of sensors selected for the operational context based on capabilities of the set of sensors and the one or more characteristics of the operational context. For example, the one or more sensors can include a set of sensors having capabilities that match one or more sensing capabilities identified/selected for the operational context based on the one or more characteristics of the operational context. In some cases, the one or more different sensors in the sensor configuration can include a different sensor(s) selected to be set to the off state or the reduced operating mode while the vehicle is in the operational context based on a mismatch between one or more capabilities of the different sensor(s) and one or more desired capabilities identified for the operational context based on the one or more characteristics of the operational context.

In some aspects, the process 300 can include detecting, based on the map data and/or additional sensor data from the at least one sensor on the vehicle, one or more different characteristics of a different operational context of the vehicle; determining, based on the one or more different characteristics of the different operational context, a different sensor configuration for the vehicle to implement when navigating the different operational context; and dynamically implementing the different sensor configuration at the vehicle when the vehicle is in the different operational context. In some examples, the different sensor configuration can include a first sensor(s) selected for use by the vehicle in the different operational context and/or a second sensor(s) set to an off state or a reduced operating mode while the vehicle is in the different operational context.

In some aspects, the process 300 can include, prior to detecting the one or more different characteristics of the different operational context, determining that the vehicle is in the different operational context or predicted to be in the different operational context during a trip of the vehicle; and in response to determining that the vehicle is in the different operational context or predicted to be in the different operational context during the trip, detecting the one or more different characteristics of the different operational context.

FIG. 4 illustrates an example processor-based system with which some aspects of the subject technology can be implemented. For example, processor-based system 400 can be any computing device making up local computing device 110, data center 150, a passenger device executing the ridehailing application 172, or any component thereof in which the components of the system are in communication with each other using connection 405. Connection 405 can be a physical connection via a bus, or a direct connection into processor 410, such as in a chipset architecture. Connection 405 can also be a virtual connection, networked connection, or logical connection.

In some examples, computing system 400 is a distributed system in which the functions described in this disclosure can be distributed within a datacenter, multiple data centers, a peer network, etc. In some cases, one or more of the described system components represents many such components each performing some or all of the function for which the component is described. In some cases, the components can be physical or virtual devices.

Example system 400 includes at least one processing unit (CPU or processor) 410 and connection 405 that couples various system components including system memory 415, such as read-only memory (ROM) 420 and random-access memory (RAM) 425 to processor 410. Computing system 400 can include a cache of high-speed memory 412 connected directly with, in close proximity to, and/or integrated as part of processor 410.

Processor 410 can include any general-purpose processor and a hardware service or software service, such as services 432, 434, and 436 stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction, computing system 400 can include an input device 445, which can represent any number of input mechanisms, such as a microphone for speech, a touch-sensitive screen for gesture or graphical input, keyboard, mouse, motion input, speech, etc. Computing system 400 can also include output device 435, which can be one or more of a number of output mechanisms known to those of skill in the art. In some instances, multimodal systems can enable a user to provide multiple types of input/output to communicate with computing system 400. Computing system 400 can include communications interface 440, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 440 may also include one or more Global Navigation Satellite System (GNSS) receivers or transceivers that are used to determine a location of the computing system 400 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 430 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L#), resistive random-access memory (RRAM/ReRAM), phase change memory (PCM), spin transfer torque RAM (STT-RAM), another memory chip or cartridge, and/or a combination thereof.

Storage device 430 can include software services, servers, services, etc., that when the code that defines such software is executed by the processor 410, causes the system to perform a function. In some examples, a hardware service that performs a particular function can include the software component stored in a computer-readable medium in connection with the necessary hardware components, such as processor 410, connection 405, output device 435, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: memory; and one or more processors coupled to the memory, the one or more processors being configured to: detect, based on at least one of map data and sensor data from at least one sensor on a vehicle, one or more characteristics of an operational context of the vehicle; determine, based on the one or more characteristics of the operational context, a sensor configuration for the vehicle to implement when navigating the operational context, the sensor configuration comprising one or more sensors selected for use by the vehicle in the operational context and one or more different sensors set to an off state or a reduced operating mode while the vehicle is in the operational context; and dynamically implement the sensor configuration at the vehicle when the vehicle is in the operational context.

Aspect 2. The system of Aspect 1, wherein the one or more processors are configured to: detect, based on at least one of the map data and additional sensor data from the at least one sensor on the vehicle, one or more different characteristics of a different operational context of the vehicle; determine, based on the one or more different characteristics of the different operational context, a different sensor configuration for the vehicle to implement when navigating the different operational context; and dynamically implement the different sensor configuration at the vehicle when the vehicle is in the different operational context.

Aspect 3. The system of Aspect 2, wherein the different sensor configuration comprises at least one of a first sensor selected for use by the vehicle in the different operational context and a second sensor set to an off state or a reduced operating mode while the vehicle is in the different operational context.

Aspect 4. The system of Aspect 2 or 3, wherein the one or more processors are configured to: prior to detecting the one or more different characteristics of the different operational context, determine that the vehicle is in the different operational context or predicted to be in the different operational context during a trip of the vehicle; and in response to determining that the vehicle is in the different operational context or predicted to be in the different operational context during the trip, detect the one or more different characteristics of the different operational context.

Aspect 5. The system of any of Aspects 1 to 4, wherein the sensor data from at least one sensor on the vehicle comprises at least one of a speed measurement associated with the vehicle, a measurement of a heading of the vehicle, image data, a distance or range measurement of one or more objects in a scene of the vehicle, a motion measurement of the one or more objects in the scene, and a measured trajectory of at least one of the vehicle and the one or more objects in the scene.

Aspect 6. The system of any of Aspects 1 to 5, wherein at least one of the operational context and the one or more characteristics of the operational context comprises at least one of a type of a driving environment associated with the vehicle, a driving intent of the vehicle, a weather associated with the driving environment, a light or brightness level in the driving environment, traffic conditions in the driving environment, a traffic rule associated with the driving environment, a type of road associated with the driving environment, and a geography associated with the driving environment.

Aspect 7. The system of any of Aspects 1 to 6, wherein the one or more different sensors in the sensor configuration are set to the reduce operating mode, and wherein the reduced operating mode comprises at least one of a reduced data collection frequency relative to a different data collection frequency of the one or more different sensors, a reduced power mode relative to a different power mode of the one or more different sensors, a reduced resolution relative to a different resolution of the one or more different sensors, a reduced framerate relative to a different framerate of the one or more different sensors, and a setting configured to reduce a resource consumption by the one or more different sensors.

Aspect 8. The system of any of Aspects 1 to 7, wherein the one or more sensors in the sensor configuration comprise a set of sensors selected for the operational context based on capabilities of the set of sensors and the one or more characteristics of the operational context, and wherein the one or more different sensors in the sensor configuration comprise at least one different sensor selected to be set to the off state or the reduced operating mode while the vehicle is in the operational context based on a mismatch between one or more capabilities of the at least one different sensor and one or more desired capabilities identified for the operational context based on the one or more characteristics of the operational context.

Aspect 9. The system of any of Aspects 1 to 8, wherein at least one of the one or more sensors and the at least one sensor on the vehicle comprises a visible-light camera sensor, a radio detection and ranging (RADAR) sensor, a time-of-flight (TOF) sensor, a light detection and ranging (LIDAR) sensor, a speedometer, an inertial measurement unit, a thermal camera sensor, and an ultrasonic sensor.

Aspect 10. The system of any of Aspects 1 to 9, further comprising the vehicle, wherein the vehicle comprises an autonomous vehicle.

Aspect 11. A method comprising: detecting, based on at least one of map data and sensor data from at least one sensor on a vehicle, one or more characteristics of an operational context of the vehicle; determining, based on the one or more characteristics of the operational context, a sensor configuration for the vehicle to implement when navigating the operational context, the sensor configuration comprising one or more sensors selected for use by the vehicle in the operational context and one or more different sensors set to an off state or a reduced operating mode while the vehicle is in the operational context; and dynamically implementing the sensor configuration at the vehicle when the vehicle is in the operational context.

Aspect 12. The method of Aspect 11, further comprising: detecting, based on at least one of the map data and additional sensor data from the at least one sensor on the vehicle, one or more different characteristics of a different operational context of the vehicle; determining, based on the one or more different characteristics of the different operational context, a different sensor configuration for the vehicle to implement when navigating the different operational context; and dynamically implementing the different sensor configuration at the vehicle when the vehicle is in the different operational context.

Aspect 13. The method of Aspect 12, wherein the different sensor configuration comprises at least one of a first sensor selected for use by the vehicle in the different operational context and a second sensor set to an off state or a reduced operating mode while the vehicle is in the different operational context.

Aspect 14. The method of Aspect 12 or 13, further comprising: prior to detecting the one or more different characteristics of the different operational context, determining that the vehicle is in the different operational context or predicted to be in the different operational context during a trip of the vehicle; and in response to determining that the vehicle is in the different operational context or predicted to be in the different operational context during the trip, detecting the one or more different characteristics of the different operational context.

Aspect 15. The method of any of Aspects 11 to 14, wherein the sensor data from at least one sensor on the vehicle comprises at least one of a speed measurement associated with the vehicle, a measurement of a heading of the vehicle, image data, a distance or range measurement of one or more objects in a scene of the vehicle, a motion measurement of the one or more objects in the scene, and a measured trajectory of at least one of the vehicle and the one or more objects in the scene.

Aspect 16. The method of any of Aspects 11 to 15, wherein at least one of the operational context and the one or more characteristics of the operational context comprises at least one of a type of a driving environment associated with the vehicle, a driving intent of the vehicle, a weather associated with the driving environment, a light or brightness level in the driving environment, traffic conditions in the driving environment, a traffic rule associated with the driving environment, a type of road associated with the driving environment, and a geography associated with the driving environment.

Aspect 17. The method of any of Aspects 11 to 16, wherein the one or more different sensors in the sensor configuration are set to the reduce operating mode, and wherein the reduced operating mode comprises at least one of a reduced data collection frequency relative to a different data collection frequency of the one or more different sensors, a reduced power mode relative to a different power mode of the one or more different sensors, a reduced resolution relative to a different resolution of the one or more different sensors, a reduced framerate relative to a different framerate of the one or more different sensors, and a setting configured to reduce a resource consumption by the one or more different sensors.

Aspect 18. The method of any of Aspects 11 to 17, wherein the one or more sensors in the sensor configuration comprise a set of sensors selected for the operational context based on capabilities of the set of sensors and the one or more characteristics of the operational context, and wherein the one or more different sensors in the sensor configuration comprise at least one different sensor selected to be set to the off state or the reduced operating mode while the vehicle is in the operational context based on a mismatch between one or more capabilities of the at least one different sensor and one or more desired capabilities identified for the operational context based on the one or more characteristics of the operational context.

Aspect 19. The method of any of Aspects 11 to 18, wherein at least one of the one or more sensors and the at least one sensor on the vehicle comprises a visible-light camera sensor, a radio detection and ranging (RADAR) sensor, a time-of-flight (TOF) sensor, a light detection and ranging (LIDAR) sensor, a speedometer, an inertial measurement unit, a thermal camera sensor, and an ultrasonic sensor.

Aspect 20. A non-transitory computer-readable medium having stored thereon instructions which, when executed by one or more processors, cause the one or more processors to perform a method according to any of Aspects 11 to 19.

Aspect 21. A system comprising means for performing a method according to any of Aspects 11 to 19.

Aspect 22. A vehicle comprising one or more computing devices configured to perform a method according to any of Aspects 11 to 19.

What is claimed is:

1. A system comprising:
a memory; and
one or more processors coupled to the memory, the one or more processors being configured to:
detect, based on at least one of map data and sensor data from at least one sensor on a vehicle, one or more characteristics of an operational context of the vehicle;
determine, based on the one or more characteristics of the operational context, a sensor configuration for the vehicle to implement when navigating the operational context, the sensor configuration comprising one or more sensors selected for use by the vehicle in the operational context and one or more different sensors set to an off state or a reduced operating mode while the vehicle is in the operational context; and
dynamically implement the sensor configuration at the vehicle when the vehicle is in the operational context.

2. The system of claim 1, wherein the one or more processors are configured to:
detect, based on at least one of the map data and additional sensor data from the at least one sensor on the vehicle, one or more different characteristics of a different operational context of the vehicle;
determine, based on the one or more different characteristics of the different operational context, a different sensor configuration for the vehicle to implement when navigating the different operational context; and
dynamically implement the different sensor configuration at the vehicle when the vehicle is in the different operational context.

3. The system of claim 2, wherein the different sensor configuration comprises at least one of a first sensor selected for use by the vehicle in the different operational context and a second sensor set to an off state or a reduced operating mode while the vehicle is in the different operational context.

4. The system of claim 2, wherein the one or more processors are configured to:
prior to detecting the one or more different characteristics of the different operational context, determine that the vehicle is in the different operational context or predicted to be in the different operational context during a trip of the vehicle; and
in response to determining that the vehicle is in the different operational context or predicted to be in the different operational context during the trip, detect the one or more different characteristics of the different operational context.

5. The system of claim 1, wherein the sensor data from at least one sensor on the vehicle comprises at least one of a speed measurement associated with the vehicle, a measurement of a heading of the vehicle, image data, a distance or range measurement of one or more objects in a scene of the vehicle, a motion measurement of the one or more objects in the scene, and a measured trajectory of at least one of the vehicle and the one or more objects in the scene.

6. The system of claim 1, wherein at least one of the operational context and the one or more characteristics of the operational context comprises at least one of a type of a driving environment associated with the vehicle, a driving intent of the vehicle, a weather associated with the driving environment, a light or brightness level in the driving environment, traffic conditions in the driving environment, a traffic rule associated with the driving environment, a type of road associated with the driving environment, and a geography associated with the driving environment.

7. The system of claim 1, wherein the one or more different sensors in the sensor configuration are set to the reduce operating mode, and wherein the reduced operating mode comprises at least one of a reduced data collection frequency relative to a different data collection frequency of the one or more different sensors, a reduced power mode relative to a different power mode of the one or more different sensors, a reduced resolution relative to a different resolution of the one or more different sensors, a reduced framerate relative to a different framerate of the one or more different sensors, and a setting configured to reduce a resource consumption by the one or more different sensors.

8. The system of claim 1, wherein the one or more sensors in the sensor configuration comprise a set of sensors selected for the operational context based on capabilities of the set of sensors and the one or more characteristics of the operational context, and wherein the one or more different sensors in the sensor configuration comprise at least one different sensor selected to be set to the off state or the reduced operating mode while the vehicle is in the operational context based on a mismatch between one or more capabilities of the at least one different sensor and one or more desired capabilities identified for the operational context based on the one or more characteristics of the operational context.

9. The system of claim 1, wherein at least one of the one or more sensors and the at least one sensor on the vehicle comprises a visible-light camera sensor, a radio detection and ranging (RADAR) sensor, a time-of-flight (TOF) sensor, a light detection and ranging (LIDAR) sensor, a speedometer, an inertial measurement unit, a thermal camera sensor, and an ultrasonic sensor.

10. The system of claim 1, further comprising the vehicle, wherein the vehicle comprises an autonomous vehicle.

11. A method comprising:
detecting, based on at least one of map data and sensor data from at least one sensor on a vehicle, one or more characteristics of an operational context of the vehicle;
determining, based on the one or more characteristics of the operational context, a sensor configuration for the vehicle to implement when navigating the operational context, the sensor configuration comprising one or more sensors selected for use by the vehicle in the operational context and one or more different sensors set to an off state or a reduced operating mode while the vehicle is in the operational context; and
dynamically implementing the sensor configuration at the vehicle when the vehicle is in the operational context.

12. The method of claim 11, further comprising:
detecting, based on at least one of the map data and additional sensor data from the at least one sensor on the vehicle, one or more different characteristics of a different operational context of the vehicle;
determining, based on the one or more different characteristics of the different operational context, a different sensor configuration for the vehicle to implement when navigating the different operational context; and
dynamically implementing the different sensor configuration at the vehicle when the vehicle is in the different operational context.

13. The method of claim 12, wherein the different sensor configuration comprises at least one of a first sensor selected for use by the vehicle in the different operational context and a second sensor set to an off state or a reduced operating mode while the vehicle is in the different operational context.

14. The method of claim 12, further comprising:
prior to detecting the one or more different characteristics of the different operational context, determining that the vehicle is in the different operational context or predicted to be in the different operational context during a trip of the vehicle; and
in response to determining that the vehicle is in the different operational context or predicted to be in the different operational context during the trip, detecting the one or more different characteristics of the different operational context.

15. The method of claim 11, wherein the sensor data from at least one sensor on the vehicle comprises at least one of a speed measurement associated with the vehicle, a measurement of a heading of the vehicle, image data, a distance or range measurement of one or more objects in a scene of the vehicle, a motion measurement of the one or more objects in the scene, and a measured trajectory of at least one of the vehicle and the one or more objects in the scene.

16. The method of claim 11, wherein at least one of the operational context and the one or more characteristics of the operational context comprises at least one of a type of a driving environment associated with the vehicle, a driving intent of the vehicle, a weather associated with the driving environment, a light or brightness level in the driving environment, traffic conditions in the driving environment, a traffic rule associated with the driving environment, a type of road associated with the driving environment, and a geography associated with the driving environment.

17. The method of claim 11, wherein the one or more different sensors in the sensor configuration are set to the reduce operating mode, and wherein the reduced operating mode comprises at least one of a reduced data collection frequency relative to a different data collection frequency of the one or more different sensors, a reduced power mode relative to a different power mode of the one or more different sensors, a reduced resolution relative to a different resolution of the one or more different sensors, a reduced framerate relative to a different framerate of the one or more different sensors, and a setting configured to reduce a resource consumption by the one or more different sensors.

18. The method of claim 11, wherein the one or more sensors in the sensor configuration comprise a set of sensors selected for the operational context based on capabilities of the set of sensors and the one or more characteristics of the operational context, and wherein the one or more different sensors in the sensor configuration comprise at least one different sensor selected to be set to the off state or the reduced operating mode while the vehicle is in the operational context based on a mismatch between one or more capabilities of the at least one different sensor and one or more desired capabilities identified for the operational context based on the one or more characteristics of the operational context.

19. The method of claim 11, wherein at least one of the one or more sensors and the at least one sensor on the vehicle comprises a visible-light camera sensor, a radio detection and ranging (RADAR) sensor, a time-of-flight (TOF) sensor, a light detection and ranging (LIDAR) sensor, a speedometer, an inertial measurement unit, a thermal camera sensor, and an ultrasonic sensor.

20. A non-transitory computer-readable medium having stored thereon instructions which, when executed by one or more processors, cause the one or more processors to:
detect, based on at least one of map data and sensor data from at least one sensor on a vehicle, one or more characteristics of an operational context of the vehicle;
determine, based on the one or more characteristics of the operational context, a sensor configuration for the vehicle to implement when navigating the operational context, the sensor configuration comprising one or more sensors selected for use by the vehicle in the operational context and one or more different sensors set to an off state or a reduced operating mode while the vehicle is in the operational context; and
dynamically implement the sensor configuration at the vehicle when the vehicle is in the operational context.
